(19) United States
(12) Patent Application Publication
(10) Pub. No.: US 2005/0193399 A1
(43) Pub. Date: Sep. 1, 2005

(54) Optical recording and/or reproducing apparatus with a buffer member

(75) Inventors: Jui-Chiang Lin, Hsinchu City (TW); Tsung-Jung Kuo, Hsinchu City (TW)

Correspondence Address: BRUCE H. TROXELL, SUITE 1404, 5205 LEESBURG PIKE, FALLS CHURCH, VA, 22041, US

(73) Assignee: LITE-ON IT Corp.

(21) Appl. No.: 11/061,815

(22) Filed: Feb. 22, 2005

(30) Foreign Application Priority Data
Feb. 27, 2004 (TW) 93202951

(51) Int. Cl. G11B 17/04; G11B 7/24

(52) U.S. Cl. 720/619

(57) ABSTRACT

An optical recording and/or reproducing apparatus includes a disk compartment having an entrance-and-exit slot defining a disk-traveling path, and a guiding groove that has a first end proximate to the disk-traveling path and a second end opposite to the first end. A guiding arm is pivoted in the disk compartment, and has a disk-contact part disposed movably in the guiding groove. A buffer member is provided at either the first end or the second end of the guiding groove so as to absorb the impact force of the disk-contact part of the guiding arm.

### FIELD OF THE INVENTION

The invention relates to an optical recording and/or reproducing apparatus, more particularly to an optical recording and/or reproducing apparatus of slot-in type.

### BACKGROUND OF THE INVENTION

An optical recording and/or reproducing apparatus of slot-in type is generally installed in a notebook computer or in an audio-and-video instrument of an automobile for reproducing the information recorded in an optical recording medium, such as playing songs from a CD.

Referring to FIGS. 1 and 2, perspective, partly exploded and bottom views of a conventional optical recording and/or reproducing apparatus 2 of slot-in type are shown to include a disk compartment that has opposite front and rear sides, and a disk entrance-and-exit slot 20 formed at the front side, a disk transport mechanism 6 disposed in the disk compartment adjacent to the entrance-and-exit slot 20, and a disk support mechanism 8. The disk transport mechanism 6 includes an, upwardly biased transport roller 61 and a guide member (not visible) that is disposed stationarily above the transport roller 61 and that slidably contacts the transport roller 61 by virtue of upwardly biased action of a spring. The entrance-and-exit slot 20 defines a disk-traveling path “L” extending from the front side to the rear side of the disk compartment. The disk compartment is further formed a pair of front guiding grooves 10, and a pair of rear guiding grooves 10. Each of the front and rear guiding grooves 10 has a first end 12 proximate to the disk-traveling path “L” and a second end 14 opposite to the first end 12. The disk support mechanism 8 includes a pair of front guiding arms 8a, a pair of rear guiding arms 8b, and urging members (not visible). Each of the front and rear guiding arms 8a, 8b is pivoted to the disk compartment, and has a disk-contact part disposed movably in a respective one of the guiding groove 10 so as to restrict movement of the respective guiding arm 8a, 8b. The urging members urge the disk-contact parts of the guiding arms 8a, 8b toward the first ends of the guiding grooves 10. Under this condition, when an optical disk 4 is inserted between the guide member and the transport roller 61 via the entrance-and-exit slot 20, the optical disk 4 will simultaneously contact the disk-contact parts of the front guiding arms 8a and the transport roller 61 in such a manner that the optical disk 4 will be drawn into or ejected from the disk compartment upon rotation of the transport roller 61 and due to applying force on the optical disk 4.

One disadvantage resulting from the use of the aforesaid conventional optical recording and/or reproducing apparatus resides in that during the disk ejection operation, since the urging action of the urging members and rotation direction of the transport roller 61 tend to be in the same direction, the collision noise of the disk-contact part of the front and rear guiding arms 8a,8b against the first ends of the guiding grooves 10 is relatively large, thereby inconveniencing the user of the optical recording and/or reproducing apparatus.

### SUMMARY OF THE INVENTION

The object of the present invention is to provide an optical recording and/or reproducing apparatus of slot-in type that has a buffer member to absorb the noise resulting from ejecting operation of an optical disk from a disk compartment of the optical recording and/or reproducing apparatus.

According to the present invention, an optical recording and/or reproducing apparatus is provided to include: a disk compartment having opposite front and rear sides, an entrance-and-exit slot at the front side thereof and via which an optical disk is adapted to be inserted into or ejected from the disk compartment, the entrance-and-exit slot defining a disk-traveling path extending from the front to rear sides, the disk compartment further having a guiding groove which is confined by a groove-defining wall having a first end proximate to the disk-traveling path and a second end opposite to the first end; a disk guiding mechanism including at least one guiding arm that is pivoted to the disk compartment and that has a disk-contact part disposed movably in the guiding groove so as to restrict movement of the guiding arm, and an urging member for urging the disk-contact part of the guiding arm toward the first end of the groove-defining wall; and a buffer member attached to the groove-defining wall at one of the first and second ends so as to absorb impact when the disk-contact part collides with a respective one of the first and second end of the groove-defining wall due to the swing action of the guiding arm during inserting and ejecting operation of the optical disk into and from the disk compartment.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 shows a perspective view a conventional disk recording and/or reproducing apparatus;

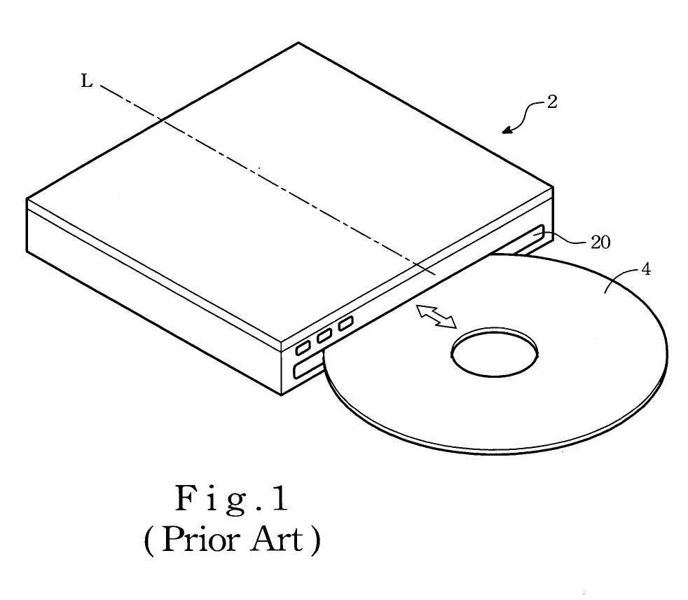

FIG. 2 is a partly exploded and bottom view, illustrating an interior of the conventional disk recording and/or reproducing apparatus;

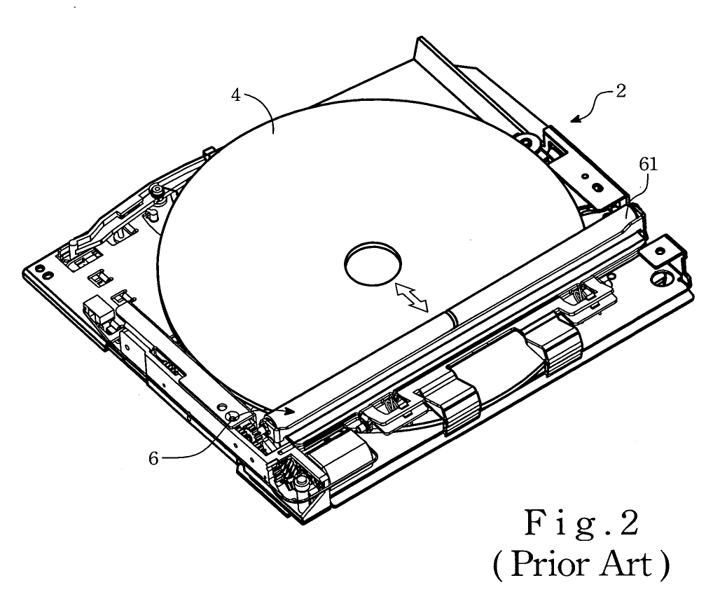

FIG. 3 is a partly exploded and top view, illustrating an interior of the conventional disk recording and/or reproducing apparatus; and

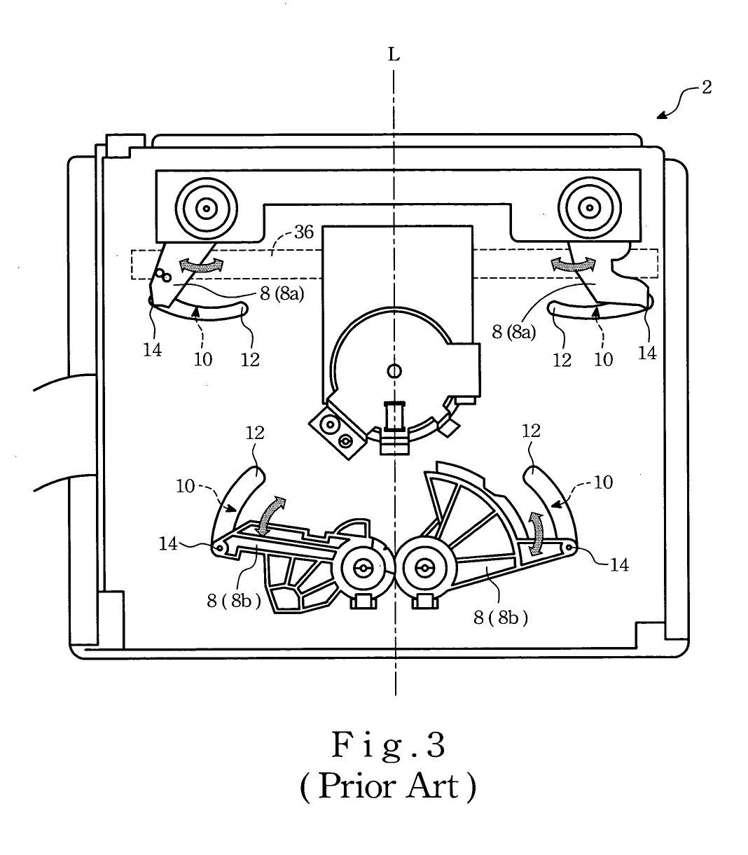

FIG. 4 is a partly exploded and top view, illustrating an interior of the preferred embodiment of an optical recording and/or reproducing apparatus according to the present invention.

### DETAILED DESCCRIPTIONS OF THE PREFERRED EMBODIMENT

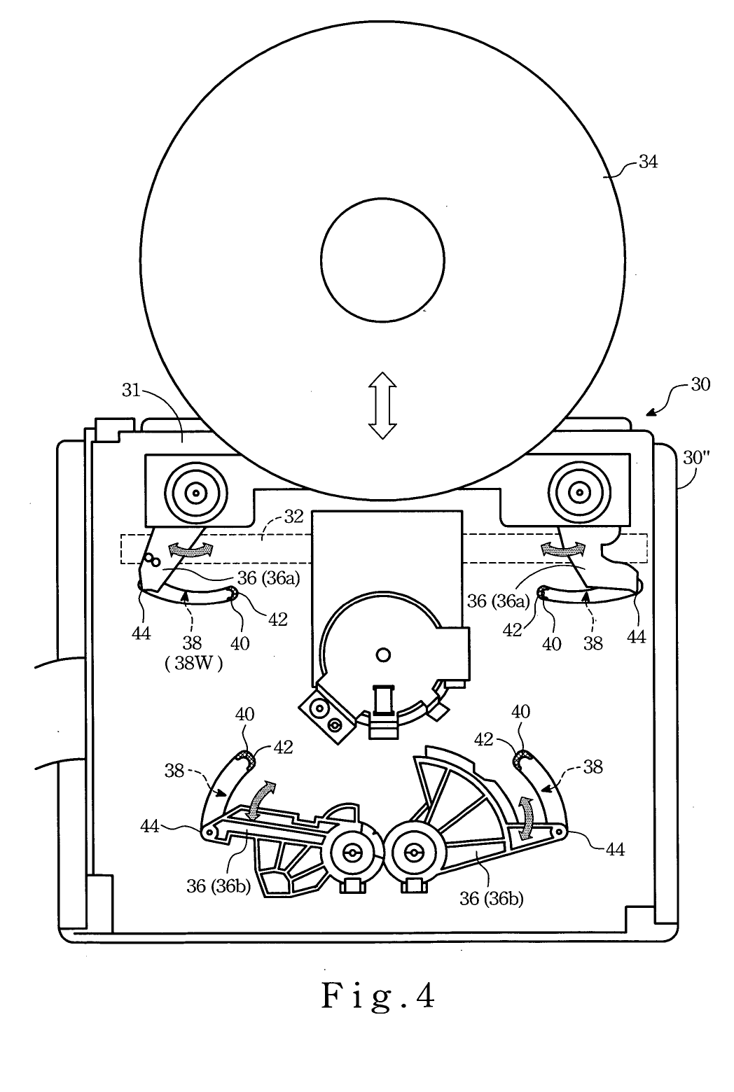

Referring to FIG. 4, a partly exploded top view of the preferred embodiment of an optical recording and/or reproducing apparatus 30 according to the present invention is shown and is generally installed in a notebook computer (not shown) or in an audio-and-video instrument of an automobile for reproducing the information recorded in an optical disk 34, such as playing out songs from a CD. The optical recording and/or reproducing apparatus is of slot-in type, and is a CD player.

As illustrated, the apparatus 30 includes a disk compartment 30″ having opposite front and rear sides and an entrance-and-exit slot 31 at the front end thereof, a disk transport mechanism (not visible), a disk support mechanism 36, and four buffer members 40. The entrance-and-exit slot 31 defines a disk-traveling path extending from the front to rear sides of the disk compartment 30″. The disk compartment 30″ further has a pair of front guiding groove 38 proximate to the entrance-and-exit slot 31 and a pair of rear guiding grooves 30 distal from the entrance-and-exit slot 31. Each of the front and rear guiding grooves 38 is confined by a groove-defining wall (38W) having a first end 42 proximate to the disk-traveling path and a second end 44 opposite to the first end 42.

The structure of the transport mechanism is similar to that disclosed in the prior art and is not the relevant feature of the present invention, a detailed description thereof is omitted herein for the sake of brevity.

The disk guiding mechanism 36 includes a pair of front guiding arms (36a), a pair of rear guiding arms (36b), and urging members (not shown). Each of the front and rear guiding arms (36a, 36b) is pivoted to the disk compartment 30″, and has a disk-contact part disposed movably within a respective one of the guiding grooves 38 so as to restrict movement of the guiding arms (36a, 36b). The urging members (not visible) urge the disk-contact parts of the front and rear guiding arms (36a, 36b) toward the first ends 42 of the groove-defining walls 38W.

Each of the buffer members 40 is attached to the groove-defining wall (38W) at the first end 42 of the respective guiding groove 38 so as to absorb impact when the disk-contact part collides the first end of the groove-defining wall 38W of the respective guiding groove 38 due to swing action of the guiding arms 36a, 36b during inserting and ejecting operation of the optical disk 34. Preferably, the buffer member 40 is made of an elastic material, and has a C-shaped configuration. Each of the buffer members 40 is attached adhesively to the first end 42 of the respective guiding groove 38.

Since provision of the buffer members 40 at the first ends 42 of the guiding grooves 38, the generating noise at the time of disk ejection operation can be minimized.

To learn by analogy, the buffer members 40 can also be disposed at the second ends 44 of the guiding grooves 38 to minimize the generating noise.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. An optical recording and/or reproducing apparatus comprising:
a disk compartment having opposite front and rear sides, an entrance-and-exit slot at said front side thereof and via which an optical disk is adapted to be inserted into or ejected from said disk compartment, said disk compartment further having a guiding groove having a first end and a second end opposite to said first end;
a disk guiding mechanism including at least one guiding arm that is pivoted to said disk compartment and that has a disk-contact part disposed movably within said guiding groove so as to restrict movement of said guiding arm; and
a buffer member attached to said first/second end so as to absorb impact during inserting and ejecting operation of the optical disk.

2. The optical recording and/or reproducing apparatus according to claim 1, further comprising a transport roller disposed within said disk compartment adjacent to said entrance-and-exit slot for drawing into and ejecting the optical disk from said disk compartment, said transport roller being movable between an upper position, in which said disk-contact part of said guiding arm is adapted to slidably contact the optical disk and in which said transport roller is adapted to abut against the optical disk such that the optical disk is drawn into a said disk compartment upon rotation of the transport roller against urging action of said urging member with said disk-contact part moving from said first end toward said second end of said groove-defining wall of said guiding groove.

3. The optical recording and/or reproducing apparatus according to claim 1, wherein said buffer member is made of an elastic material.

4. The optical recording and/or reproducing apparatus according to claim 1, wherein the optical recording and/or reproducing apparatus is an optical disc drive of slot-in type.

5. The optical recording and/or reproducing apparatus according to claim 1, wherein said buffer member is C-shaped cross section.
